(19) United States
(12) Patent Application Publication
(10) Pub. No.: US 2024/0129214 A1
(43) Pub. Date: Apr. 18, 2024

(54) METHODS AND APPARATUS FOR TELEMETRY GRANULARITY MANAGEMENT

(71) Applicant: Intel Corporation, Santa Clara, CA (US)

(72) Inventors: Mario Jose Divan Koller, Hillsboro, OR (US); Francesc Guim Bernat, Barcelona (ES); Manish Dhananjay Dave, Folsom, CA (US); Marcos Emanuel Carranza, Portland, OR (US); Xiangyang Zhuang, Lake Zurich, IL (US); Adrian Christopher Hoban, Cratloe (IE)

(21) Appl. No.: 18/397,791

(22) Filed: Dec. 27, 2023

(51) Int. Cl. H04L 43/0864; H04L 43/04; H04N 7/18

(52) U.S. Cl. CPC H04L 43/0864; H04L 43/04; H04N 7/181

(57) ABSTRACT

An example first device disclosed includes interface circuitry, machine readable instructions, and programmable circuitry to operate based on the machine readable instructions to update configuration data based on a telemetry pattern from a second device, the second device to satisfy a neighbor condition, generate telemetry data based on the configuration data, and update the first set of data based on feedback from a recipient of the telemetry data.

### FIELD OF THE DISCLOSURE

This disclosure relates generally to software processing, and, more particularly, to methods and apparatus for telemetry granularity management.

### BACKGROUND

Telemetry is widely used for remotely monitoring the health, security, and performance of applications in real time. For example, software developers and information technology (IT) administrators can detect startup and processing times, resource use, and/or perform an overall assessment of the state of a system based on the incoming data. In some examples, telemetry can be measured using monitoring tools such as servers, networks, applications, and/or cloud-based systems. Likewise, telemetry is applicable in fields such as meteorology, agriculture, and healthcare, among others.

### BRIEF DESCRIPTION OF THE DRAWINGS

FIG. 1 illustrates a first example environment including video pipeline streams associated with telemetry data used for a decision-making process.

FIG. 2 illustrates a second example environment including multiple feedback loops associated with telemetry data from multiple video pipeline streams.

FIG. 3 is a block diagram representative of the telemetry manager circuitry that implements sharing of telemetry data analyses for swarm intelligence among edge devices.

FIG. 4 is a flowchart representative of example machine-readable instructions and/or example operations that may be executed, instantiated, and/or performed by example programmable circuitry to implement the example telemetry manager circuitry of FIG. 3.

FIG. 5 is a flowchart representative of example machine-readable instructions and/or example operations that may be executed, instantiated, and/or performed by example programmable circuitry to implement the example telemetry manager circuitry of FIG. 3 to update pattern(s) based on feedback.

FIG. 6 is an example of an architecture used for performing telemetry resource management associated with edge devices.

FIG. 7 in an example stage-based process for performing telemetry data collection, variability analysis, iterative granularity assessment, and optimization and tracking based on a feedback loop associated with a decision maker.

FIG. 8 is an example of pattern sharing, including data content for telemetry, granularity level, events, and magnitudes of contribution to objective-oriented decision-making processes.

FIG. 9 is a block diagram of an example processing platform including programmable circuitry structured to execute, instantiate, and/or perform the example machine readable instructions and/or perform the example operations of FIGS. 4 and/or 5 to implement the telemetry manager circuitry of FIG. 3.

FIG. 10 is a block diagram of an example implementation of the programmable circuitry of FIG. 9.

FIG. 11 is a block diagram of another example implementation of the programmable circuitry of FIG. 9.

FIG. 12 is a block diagram of an example software/firmware/instructions distribution platform (e.g., one or more servers) to distribute software, instructions, and/or firmware (e.g., corresponding to the example machine readable instructions of FIGS. 4 and/or 5) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

### DETAILED DESCRIPTION

Telemetry permits recording and transmission of data from remote or inaccessible sources for monitoring and analysis at information technology (IT) systems in different locations. While telemetry is commonly used in software development, it is also widely applicable in fields such as meteorology, artificial intelligence, and hospital-based settings, among others. For example, sensors positioned at a remote source measure physical or electrical data. Physical data collection can include precipitation, pressure, or temperature, while electrical data collection can include current and voltage data. The stream of data is transmitted using wireless or wired networks. As such, a user of the system can monitor an environment remotely. Telemetry can be collected using various monitoring system platforms. Data acquisition methods can be selected to pass the telemetry data to the monitoring platform. For example, a pull-based monitoring system actively obtains indicators, such that the objects being monitored need to be accessed remotely, while a push-based monitoring system involves monitored objects actively pushing the indicators (e.g., metrics). A decision-making process relevant to a particular environment (e.g., weather monitoring, medical-based monitoring, etc.) can be supported using telemetry-based methods when the raw telemetry data is good enough to support the decision-making process. However, without feedback, telemetry-based data collection continues under the same schema once the monitoring data is transmitted. In some examples, local data collection policies can be established to increase or decrease data aggregation and/or the data transmission frequency. For example, such policies may use a previous implementation directive (e.g., using local data collection or transmission frequency policies). As such, at least some supervision is beneficial to orient the telemetry-based data processing (e.g., per edge device(s) that collect or communicate the telemetry data).

Methods and apparatus disclosed herein permit telemetry-based granularity management. In examples disclosed herein, an autonomous and dynamic monitoring mechanism focusing on the telemetry in an individual edge device determines how the telemetry detail level and variability contribute to a global measurement objective. In examples disclosed herein, telemetry-based data collection can be adjusted based on a feedback loop. For example, local decisions (e.g., adjustment of telemetry data granularity levels, metric combinations, events, etc.) and determined impacts on the global measurement objective permit identification of local patterns. A knowledge database is created based on proper and third patterns, with debugging performed over time to keep pertinency of the patterns aligned with the global measurement aim. As such, methods and apparatus disclosed herein foster pattern sharing among edge devices and swarm intelligence, allowing individual nodes to decide autonomously (e.g., using artificial intelligence) whether to incorporate third patterns as determined based on local utility. For example, patterns are used to update and change edge device-based local data collection, processing, data buffering, and/or data transmission strategy over time.

Methods and apparatus disclosed herein determine what metrics and/or set of metrics can be synthesized or detailed to describe the local system variability under monitoring. Furthermore, methods and apparatus disclosed herein permit local knowledge about local variability to be shared among edge devices to create swarm intelligence, which corresponds to collective intelligence among edge devices, where individual edge devices are able to recognize and share critical information with each other. In particular, methods and apparatus disclosed herein introduce an autonomous mechanism that can read, analyze, and/or learn from multidimensional local telemetry data autonomously to dynamically determine a proper level of granularity and/or representative metrics with the capacity to share the granularity and/or metric determinations to create swarm intelligence among the edge devices. Likewise, iterative collection from the decision-making process to fit the local cost and/or benefit strategy is a beneficial addition to telemetry-based data collection and analysis.

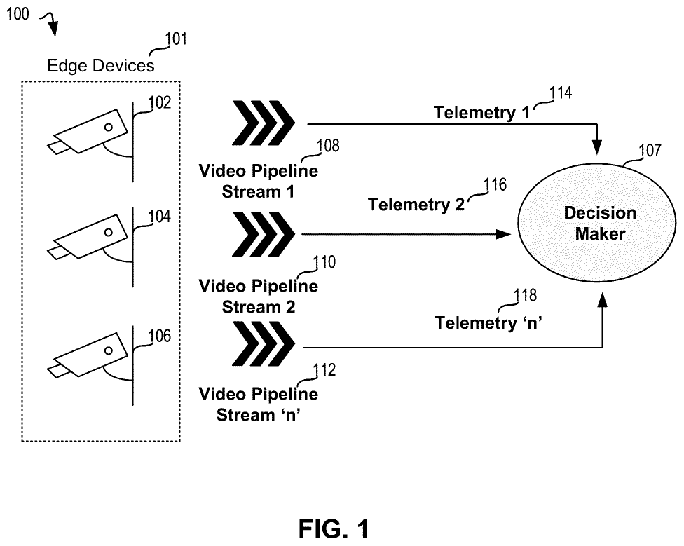

FIG. 1 illustrates a first example environment 100 including video pipeline streams associated with telemetry data used for a decision-making process. In the example of FIG. 1, edge device(s) 101 (e.g., camera(s) 102, 104, 106) are positioned in locations that permit collection of data that is of interest to a decision maker 107. The decision maker 107 can be any type of process, application, entity, individual, etc., interested in the collection and assessment of telemetry data for a certain measurement objective. For example, the decision maker 107 can be a provider of weather forecasts monitoring different weather stations, a provider of surveillance services monitoring different locations of interest, and/or any other type of data collection entity providing services in fields such as software development, meteorology, agriculture, defense, or healthcare. While in the example of FIG. 1 the decision maker 107 is shown collection telemetry-based data using camera(s) 102, 104, 106, the decision maker 107 can collect any other type of data, including, but not limited to, electrical data (e.g., voltage, current, etc.), physical data (e.g., temperature, pressure, etc.), etc. As such, the decision maker 107 can assist in the monitoring and analysis of the collected telemetry maker, determining whether the data is relevant to a certain measurement objective. In the example of FIG. 1, the camera(s) 102, 104, 106 transmit video pipeline stream(s) 108, 110, 112, respectively. The video pipeline stream(s) 108, 110, 112 correspond to live video transmissions streams. The video pipeline stream(s) 108, 110, 112 can include capturing raw video, compressing the video, delivering the video data in the form of telemetry data 114, 116, 118, and/or decompressing the video data. In the example of FIG. 1, the telemetry data 114, 116, 118 includes real-time data collection from the camera(s) 102, 104, 106 that is transmitted to the decision maker 107.

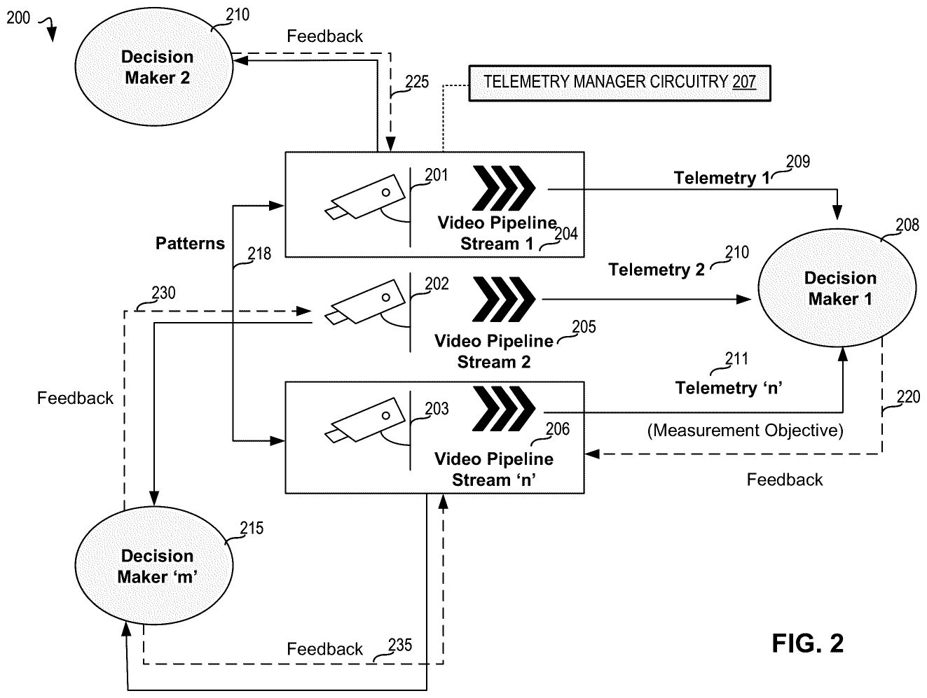

In the example of FIG. 1, there is a general assumption that the raw data is adequate to support a decision-making process by the decision maker 107 (e.g., data-driven decision making based on data volume, data meaning, etc.). For example, there is no discrimination between data and information. In the illustrated example of FIG. 1, local data aggregation and data transmission can be based on policies (e.g., types of metrics that are of interest for collection based on the telemetry data, locations of interest for data collection, etc.). However, in the illustrated example, no local decisions are made about metrics to be synthesized or detailed to optimize the information related to system variability. Further, in the illustrated example of FIG. 1, local knowledge about system variability is not shared with other edge devices (e.g., to create swarm intelligence). For example, there is an absence of local learning from multi-dimensional telemetry that can be used to determine the level of details and relevant metrics (e.g., prioritization) to obtain from the telemetry-based data input. As such, in the illustrated example of FIG. 1, there is an absence of collaboration between nodes based on the collected telemetry, an absence of leaning between the nodes (e.g., even though there may be valuable information that could be obtained), and an absence of feedback between the nodes (e.g., lack of knowledge sharing). Methods and apparatus disclosed herein address those limitations to improve telemetry data-based management among edge devices for swarm intelligence. For example, methods and apparatus disclosed herein allow for the sharing of patterns between nodes to create a knowledge base that can be used by the decision maker(s) to meet a measurement objective, as described in more detail in connection with FIG. 2.

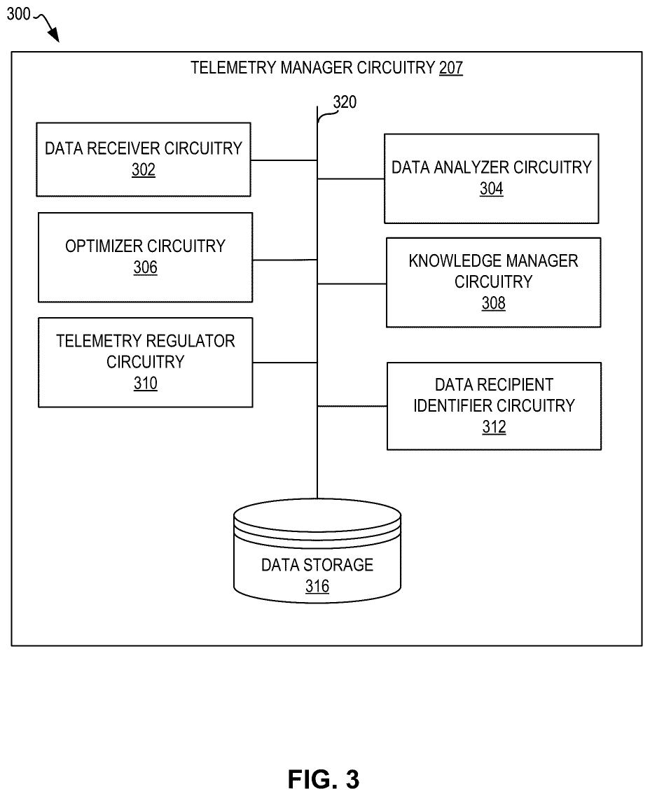

FIG. 2 illustrates a second example environment 200 including multiple feedback loops associated with telemetry data from multiple video pipeline streams. In the illustrated example, the individual edge devices (e.g., camera(s) 201, 202, 203 with video pipeline stream(s) 204, 205, 206 and telemetry data 209, 210, 211) include respective example telemetry manager circuitry 207 for dynamic monitoring to determine the level of detail and variability in the telemetry data based on the generation of local patterns (e.g., based on a set of metrics, a level of detail per metric, etc.). In the example of FIG. 2, the telemetry manager circuitry 207 shares local patterns between nodes to create a knowledge base (e.g., of telemetry patterns) that can be used for purposes of swarm intelligence among the edge device(s), as described in more detail in connection with FIG. 3. In the example of FIG. 2, data sources can be shared among multiple telemetry consumers (e.g., decision makers), where the consumer can provide relevant feedback (e.g., based on how helpful the provided information was for a particular decision, etc.). In some examples, learned patterns can be used to pursue a global alignment (e.g., based on service level agreements, etc.). For example, FIG. 2 includes multiple decision maker(s) 208, 210, 215 that share telemetry-based data analysis feedback with the edge device(s) (e.g., camera(s) 201, 202, 203). For example, data from the camera(s) 201, 202, 203 can be provided to the decision maker(s) 208, 210, 215 to determine whether the data is relevant to their particular measurement objective(s). Based on the collected data, the telemetry manager circuitry 207 generates patterns 218 and shares them between nodes to create a knowledge base that can be used for purposes of swarm intelligence. For example, the patterns 218 can include generated patterns specific to the edge device, depending on the types of metrics that are being collected by the given device. The decision maker(s) 208, 210, 215 provide feedback 220, 225, 230, 235 that indicates whether the provided telemetry data is relevant for that particular decision maker. As such, the telemetry manager circuitry 207 at the edge device(s) can adjust the obtained data (e.g., type of metric, frequency of data collection, etc.) based on the feedback 220, 225, 230, 235 from one or more decision maker(s) 208, 210, 215.

For example, multiple decision maker(s) 208, 210, 215 can consume the same telemetry data, but the decision maker(s) 208, 210, 215 can have different decision-making processes and/or objectives. As such, the decision maker(s) 208, 210, 215 may provide different feedback 220, 225, 230, 235 to the edge devices (e.g., camera(s) 201, 202, 203). The telemetry manager circuitry 207 at the edge device adjusts the collected telemetry dynamically based on the received feedback (e.g., determining which metrics to continue to collect or not to collect, adjusting the frequency of data collection, etc.). In some examples, an edge device (e.g., camera 201) can receive feedback from one decision maker (e.g., decision maker 210), while in other examples an edge device (e.g., camera 203) can receive feedback (e.g., feedback 220, 235) from multiple decision makers (e.g., decision makers 208, 215). If the feedback is received from multiple decision maker(s), the edge device (e.g., camera 203) determines, using the telemetry manager circuitry 207, which metrics are relevant to the decision maker(s). For example, out of a total of ten metrics, the first seven metrics may be useful to decision maker 208 and the last three metrics may be useful to decision maker 215. As such, the telemetry manager circuitry 207 can generate a pattern that is specific to the type of data that is of interest to a particular decision maker. For example, the edge device may collect all ten metrics, but only report the first seven metrics to decision maker 208 and the last three metrics to decision maker 215. As additional feedback is received from other decision maker(s), the telemetry manager circuitry 207 adjusts the local pattern accordingly to optimize the type of data collection to perform, as described in more detail in connection with FIG. 3. Likewise, the edge device(s) can share the information between them (e.g., cameras 201, 203 share pattern(s) 218) to permit the edge device(s) to determine whether a particular existing pattern would be useful to the decision maker(s) that receive telemetry data from that edge device. For example, a particular pattern can allow the decision maker to converge to a particular decision faster, allowing the entire system to function more efficiently by providing customized data that is relevant to the decision maker(s).

FIG. 3 is a block diagram 300 of an example implementation of the telemetry manager circuitry 207 of FIG. 2 to perform telemetry-based data management at the edge device(s) 101 of FIGS. 1-2. The telemetry manager circuitry 207 of FIG. 2 may be instantiated (e.g., creating an instance of, bring into being for any length of time, materialize, implement, etc.) by programmable circuitry such as a Central Processing Unit (CPU) executing first instructions. Additionally or alternatively, the telemetry manager circuitry 207 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

In the example of FIG. 2, the telemetry manager circuitry 207 includes example data receiver circuitry 302, example data analyzer circuitry 304, example optimizer circuitry 306, example knowledge manager circuitry 308, example telemetry regulator circuitry 310, example data recipient identifier circuitry 312, and/or example data storage 316. In the example of FIG. 3, the data receiver circuitry 302, the data analyzer circuitry 304, the optimizer circuitry 306, the knowledge manager circuitry 308, the telemetry regulator circuitry 310, the data recipient identifier circuitry 312, and/or the data storage 316 are in communication via an example bus 320.

The data receiver circuitry 302 receives data from the decision maker(s) 208, 210, 215. For example, the decision maker(s) 208, 210, 215 identify metrics that are of interest based on specific measurement objective(s) (e.g., data collection frequency, duration, granularity of data, variability of data, etc.). Over time, the decision maker(s) 208, 210, 215 provide feedback to the edge device (e.g., camera(s) 201, 202, 203) via a feedback loop (e.g., feedback 220, 225, 230, 235), indicating whether the collected data is relevant to the objectives of a decision-making process (e.g., surveillance objectives, weather tracking objectives, hospital-based monitoring objectives, etc.). In some examples, the data receiver circuitry 302 receives initial data from the edge device (e.g., temperature, pressure, video recording, etc.) that can be used for further adjustment, assessment and/or analysis prior to being transmitted to the one or more decision maker(s) 208, 210, 215. In some examples, the data receiver circuitry 302 receives data from other edge device(s) (e.g., telemetry data) and/or receives local patterns generated by other edge device(s) that can be used for determining the type of telemetry data collection that can be beneficial to a particular decision maker (e.g., based on a similar measurement objective). For example, a first edge device (e.g., camera 102) providing information to a first decision maker focusing on weather monitoring and/or prediction can inform a second edge device (e.g., camera 104) as to the data collection schema (e.g., local pattern(s)) that is useful to the first decision maker when the second edge device starts to provide telemetry data to a second decision maker that has a similar measurement objective (e.g., weather monitoring).

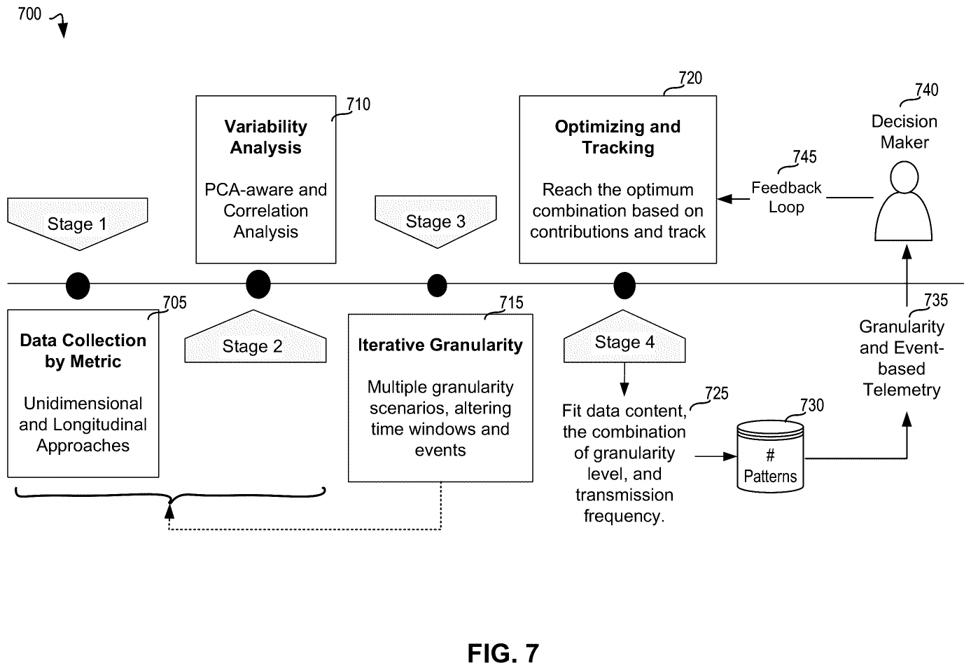

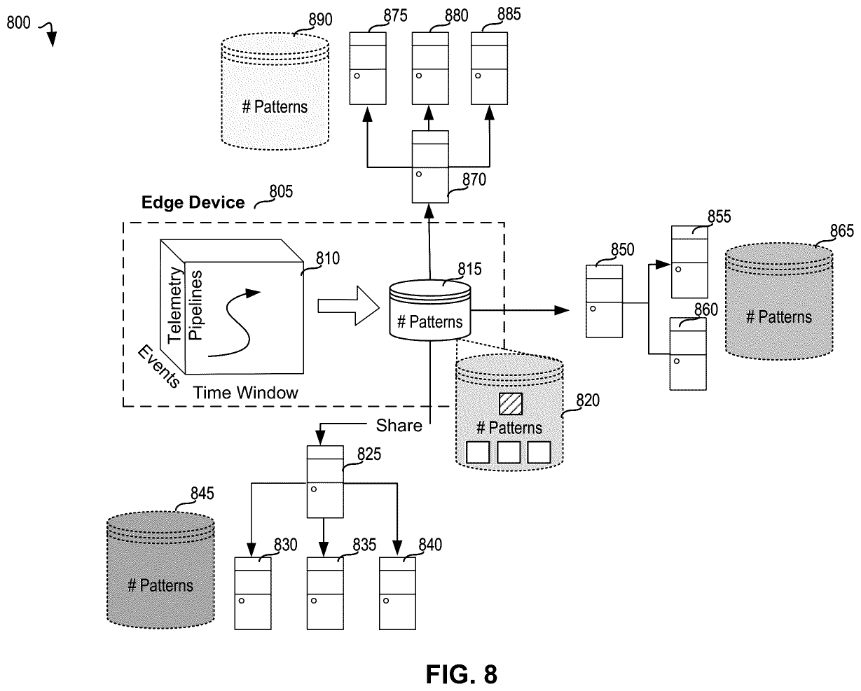

The data analyzer circuitry 304 performs different levels of data analysis on the telemetry data obtained by the edge device. In some examples, the data analyzer circuitry 304 performs specific combinations and/or syntheses of the telemetry data obtained using the data receiver circuitry 302. In some examples, the data analyzer circuitry 304 performs the data analysis based on optimization performed (e.g., by the optimizer circuitry 306) to determine the type of analysis that can provide useful information to the decision maker(s) 208, 210, 215. For example, the data receiver circuitry 302 performs telemetry data collection (e.g., based on metric identifiers, etc.), while the data analyzer circuitry 304 performs analyses on the raw telemetry data (e.g., low-level analyses). For example, the analyses can include unidimensional analysis (e.g., descriptive analysis, outlier analysis, missing value analysis, etc.) and/or longitudinal analysis (e.g., multivariate outlier analysis) for a given time window and set of events (e.g., energy consumption peak, processor frequency peaks, etc.). In some examples, the data analyzer circuitry 304 analyzes how a certain combination of variables could affect system variability over time under a given granularity level and/or set of events. In some examples, the data analyzer circuitry 304 varies the granularity levels and potential events on existing analysis pipelines by replacing and/or altering metrics with equal or different levels of granularity, as shown in more detail in connection with FIG. 7. As such, the data analyzer circuitry 304 generates telemetry-based pattern data based on the telemetry data features (e.g., granularity, variability, etc.). An individual edge device (e.g., edge device(s) 201, 202, 203) can generate and store local pattern data based on the data features associated with a given set of telemetry data (e.g., data features selected based on the type of decision maker receiving the telemetry data, etc.). Gradually, the various patterns can be collected in a knowledge database (e.g., pattern database with configuration data) accessible by the edge device(s), allowing the edge device to select the type of telemetry pattern to implement based on decision maker preferences and/or data collection goals, as shown in more detail in connection with FIG. 8.

The optimizer circuitry 306 uses the knowledge database containing telemetry-based pattern data to create a search space and reach an optimal combination of content, granularity, and/or variability to produce added value for the global measurement objective of a decision maker In some examples, the optimizer circuitry 306 receives, processes, and/or updates the local knowledge database (e.g., configuration data) asynchronously with a feedback loop received from a decision maker process running a global optimization workload. For example, the decision maker can provide feedback indicating whether the last informed telemetry served the purpose of supporting a particular measurement objective. In some examples, the decision maker provides input based on a score between 0% and 100% to describe the level of utility associated with previous telemetry-based data received from the edge device. In some examples, the optimizer circuitry 306 assesses feedback loop data received from the decision-making process about past telemetry-based data contributions, creates a search space using this information, and/or runs an artificial intelligence (AI)-based optimization algorithm. For example, the optimizer circuitry 306 determines a combination pattern of granularity levels per data metric that can be used to monitor the data jointly with the transmission frequency to adjust the local telemetry system. As such, the optimizer circuitry 306 identifies the optimal combination of content, granularity, and/or variability, resulting in adjustments to the telemetry pattern data associated with a particular decision maker.

The knowledge manager circuitry 308 autonomously and/or dynamically updates and/or debugs the local patterns generated by the edge device based on the contribution of the telemetry data to the decision maker's measurement objective over time. For example, the knowledge manager circuitry 308 receives pattern data generated locally by a given edge device and/or pattern data associated with neighboring edge device(s). For example, the pattern data can locally represent knowledge based on previous experiences with the decision maker(s) resulting from feedback received from the decision maker(s). For example, such pattern data can indicate the data content for telemetry, granularity level, events, and/or the magnitude of data contribution to the objective-oriented decision-making process (e.g., global power consumption optimization). For example, the knowledge manager circuitry 308 receives pattern data from edge device(s) that are in physical proximity to each other. However, the knowledge manager circuitry 308 can receive pattern data from edge device(s) that fulfill other criteria. Such criteria can include latency (e.g., edge device(s) reachable in at least 1 millisecond, etc.). In some examples, the knowledge manager circuitry 308 identifies which edge device(s) are associated with particular decision maker(s) and locates pattern data associated with these edge device(s).

The telemetry regulator circuitry 310 implements the directives (e.g., patterns) that the optimizer circuitry 306 provides to update and change the local data collection, processing, data buffering, and/or data transmission strategy over time. In some examples, the telemetry regulator circuitry 310 selects a pattern from the pattern database (e.g., configuration data) that is a best match to the type and/or characteristic of data collection that achieves the goals of a particular decision maker In some examples, the telemetry regulator circuitry 310 can regulate the telemetry data collection process based on a knowledge base of the patterns being shared by neighboring edge device(s). For example, when the optimizer circuitry 306 determines that the decision maker's feedback loop identifies that previously sent telemetry data as lacking utility to the decision maker (e.g., a data metric being collected is not needed, etc.), the telemetry regulator circuitry 310 updates the telemetry data collection process to change and/or update the telemetry pattern being used. As such, the telemetry regulator circuitry 310 can dynamically fit the behavior and/or content of telemetry data based on the global measurement aim(s) of the decision maker(s) that receive the telemetry data. For example, informed telemetry is valued according to the feedback loop from the decision maker(s), allowing for the creation and/or updating of utility patterns to learn from past experiences autonomously and dynamically. Furthermore, the AI-based swarm intelligence approach used herein (e.g., based on telemetry pattern collection and/or sharing with neighboring edge devices) allows for the usage of the learned patterns to pursue a continuous and dynamic alignment with the measurement objective.

The data recipient identifier circuitry 312 receives information from the decision maker(s) via a feedback loop. In some examples, the data recipient identifier circuitry 312 identifies the edge device(s) from which to receive pattern data or provide the local pattern data to as part of swarm intelligence. For example, pattern data can be shared collaboratively among neighbor nodes to increase the pattern-based knowledge database and transitively enrich the search space for AI-based optimization. For example, an edge node corresponds to a physical or virtual machine located at the edge of a network. Neighboring nodes can refer to nodes that are located within a designated proximity from each other and/or share other characteristics (e.g., such as a particular latency between nodes, etc.). As such, an edge device can receive data from a neighboring edge device when the neighboring edge device satisfies a neighbor condition (e.g., based on latency, physical proximity, etc.). Different edge devices can have different perspectives of the knowledge database depending on their neighbor nodes, allowing for the mitigation of local optimization concerns through swarm intelligence. The edge device(s) can share their patterns and decide autonomously whether other patterns can be incorporated or retained over time from the other neighbor edge device(s) based on the potential contribution that such pattern(s) can provide to the edge device database. If a given pattern from another edge device does not increase the benefit of global variability in a particular instant, such a pattern can be omitted or removed, keeping a record of this decision. As such, when a new edge device joins the network of edge device(s) that are in communication, the newly added edge device can receive access to the knowledge database of telemetry pattern data and use select pattern(s) during telemetry data collection for a particular decision maker.

The data storage 316 can be used to store any information associated with the data receiver circuitry 302, the data analyzer circuitry 304, the optimizer circuitry 306, the knowledge manager circuitry 308, the telemetry regulator circuitry 310, and/or the data recipient identifier circuitry 312. The example data storage 316 of the illustrated example of FIG. 3 can be implemented by any memory, storage device and/or storage disc for storing data such as flash memory, magnetic media, optical media, etc. Furthermore, the data stored in the example data storage 316 can be in any data format such as binary data, comma delimited data, tab delimited data, structured query language (SQL) structures, image data, etc.

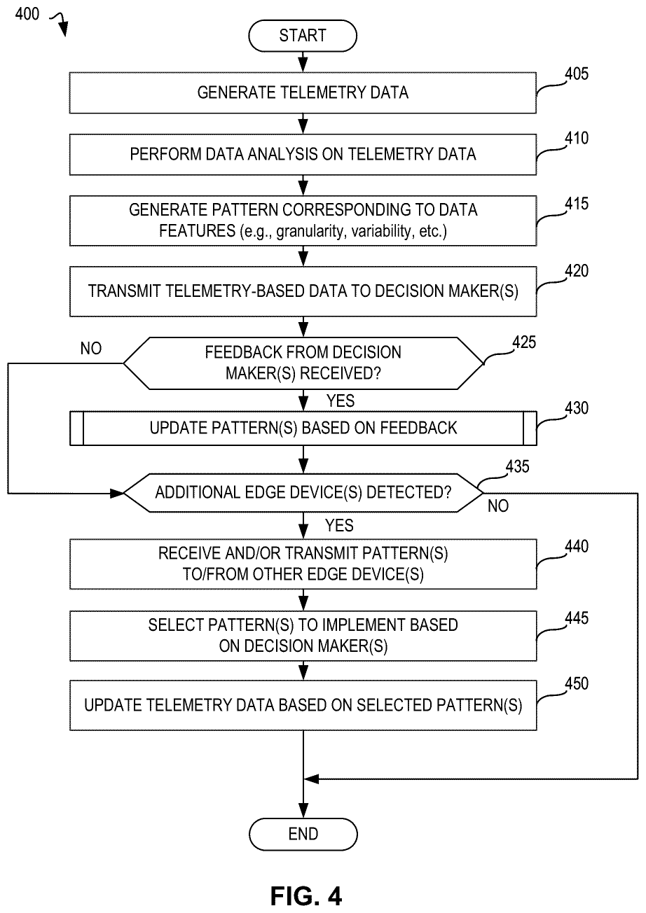

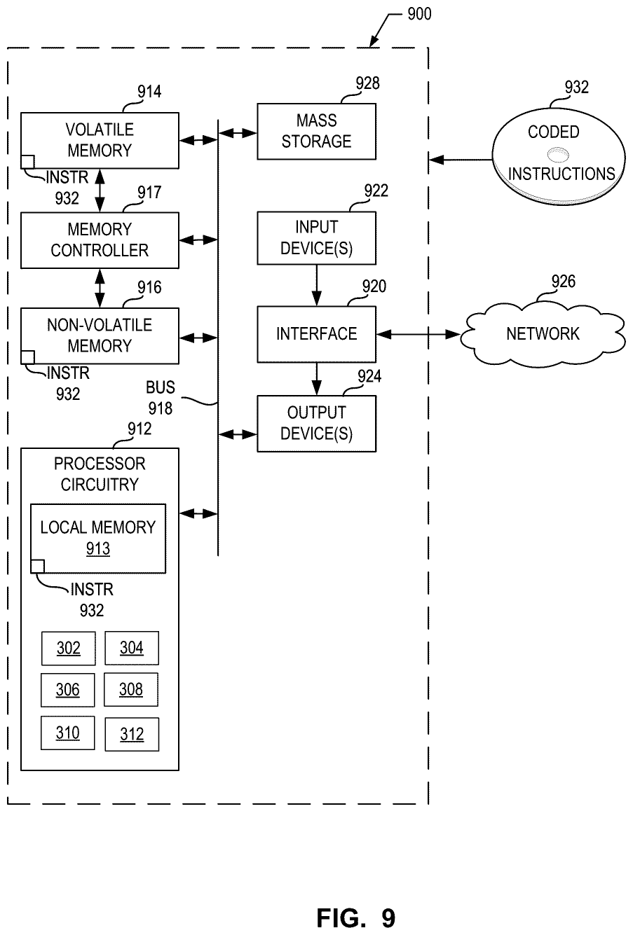

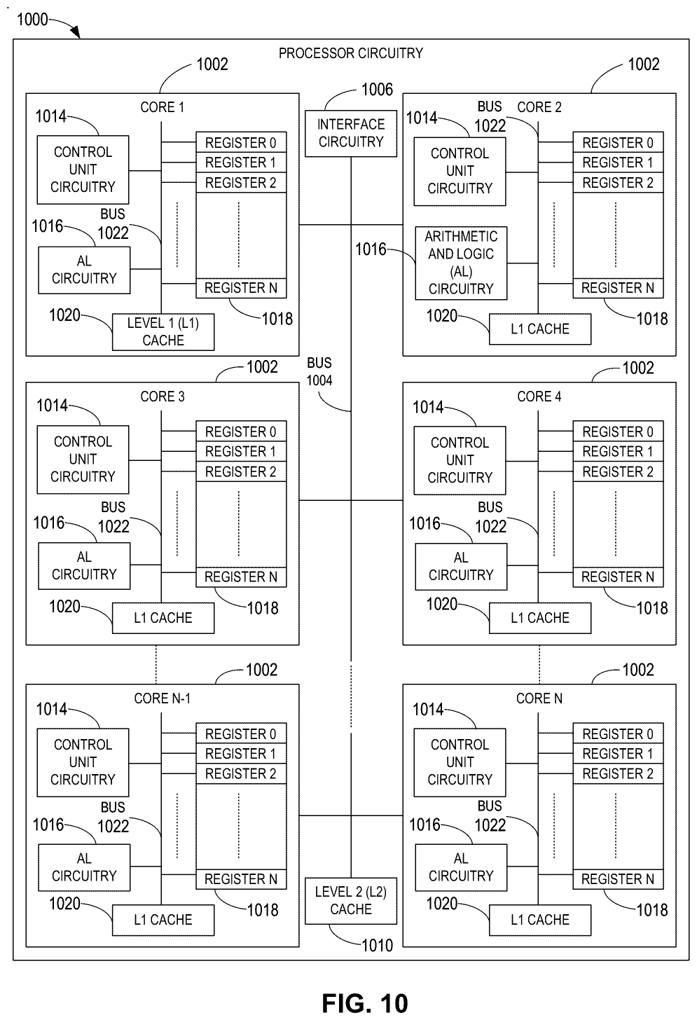

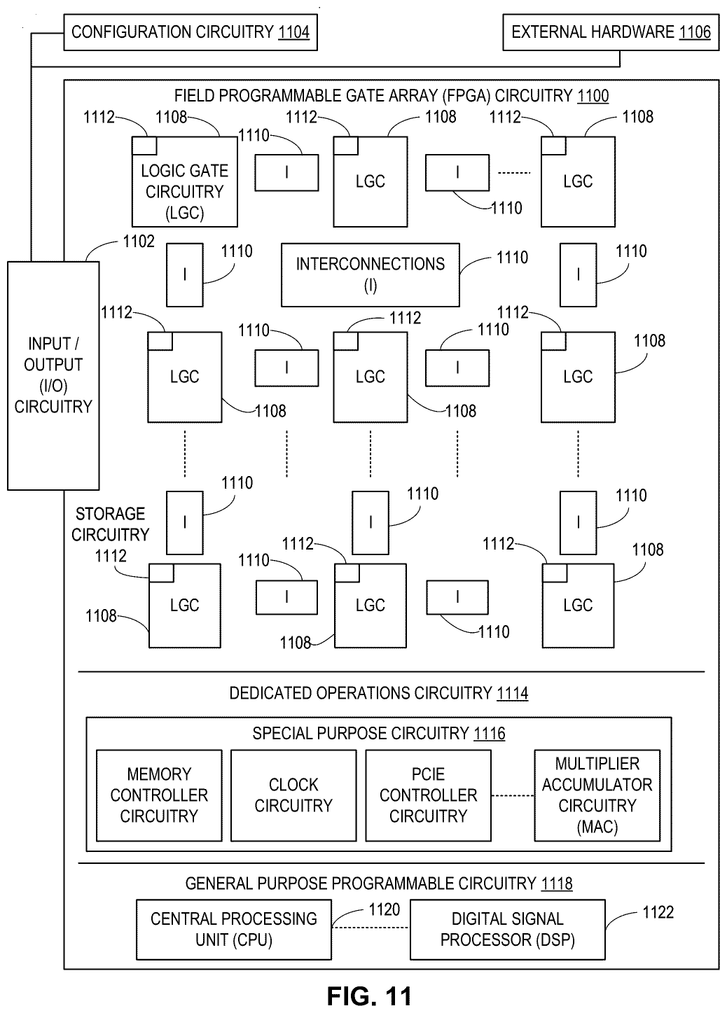

In some examples, the apparatus includes means for receiving data. For example, the means for receiving data may be implemented by the data receiver circuitry 302. In some examples, the data receiver circuitry 302 may be instantiated by programmable circuitry such as the example programmable circuitry 912 of FIG. 9. For instance, the data receiver circuitry 302 may be instantiated by the example microprocessor 1000 of FIG. 10 executing machine executable instructions such as those implemented by at least block 405 of FIG. 4. In some examples, the data receiver circuitry 302 may be instantiated by hardware logic circuitry, which may be implemented by an ASIC, XPU, or the FPGA circuitry 1100 of FIG. 11 structured to perform operations corresponding to the machine readable instructions. Additionally or alternatively, the data receiver circuitry 302 may be instantiated by any other combination of hardware, software, and/or firmware. For example, the data receiver circuitry 302 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for analyzing data. For example, the means for analyzing data may be implemented by the data analyzer circuitry 304. In some examples, the data analyzer circuitry 304 may be instantiated by programmable circuitry such as the example programmable circuitry 912 of FIG. 9. For instance, the data analyzer circuitry 304 may be instantiated by the example microprocessor 1000 of FIG. 10 executing machine executable instructions such as those implemented by at least blocks 410, 415 of FIG. 4. In some examples, the data analyzer circuitry 304 may be instantiated by hardware logic circuitry, which may be implemented by an ASIC, XPU, or the FPGA circuitry 1100 of FIG. 11 structured to perform operations corresponding to the machine readable instructions. Additionally or alternatively, the data analyzer circuitry 304 may be instantiated by any other combination of hardware, software, and/or firmware. For example, the data analyzer circuitry 304 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for optimizing data. For example, the means for optimizing data may be implemented by the optimizer circuitry 306. In some examples, the optimizer circuitry 306 may be instantiated by programmable circuitry such as the example programmable circuitry 912 of FIG. 9. For instance, the optimizer circuitry 306 may be instantiated by the example microprocessor 1000 of FIG. 10 executing machine executable instructions such as those implemented by at least block 430 of FIG. 4. In some examples, the optimizer circuitry 306 may be instantiated by hardware logic circuitry, which may be implemented by an ASIC, XPU, or the FPGA circuitry 1100 of FIG. 11 structured to perform operations corresponding to the machine readable instructions. Additionally or alternatively, the optimizer circuitry 306 may be instantiated by any other combination of hardware, software, and/or firmware. For example, the optimizer circuitry 306 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

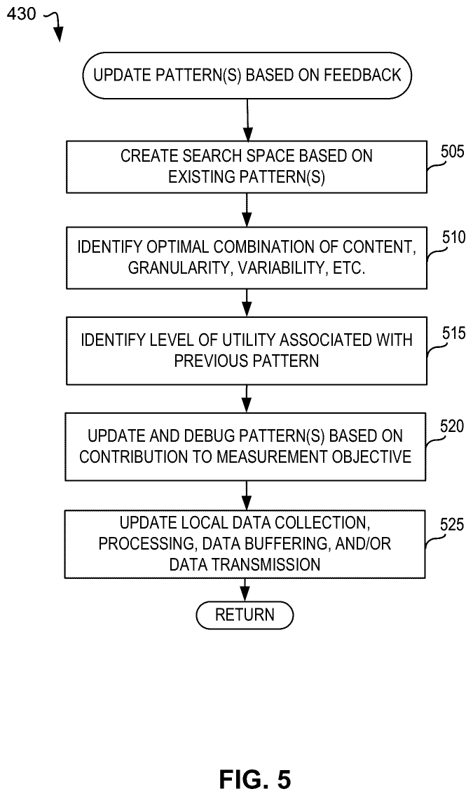

In some examples, the apparatus includes means for managing a pattern database. For example, the means for managing a pattern database may be implemented by the knowledge manager circuitry 308. In some examples, the knowledge manager circuitry 308 may be instantiated by programmable circuitry such as the example programmable circuitry 912 of FIG. 9. For instance, the knowledge manager circuitry 308 may be instantiated by the example microprocessor 1000 of FIG. 10 executing machine executable instructions such as those implemented by at least blocks 515, 520 of FIG. 5. In some examples, the knowledge manager circuitry 308 may be instantiated by hardware logic circuitry, which may be implemented by an ASIC, XPU, or the FPGA circuitry 1100 of FIG. 11 structured to perform operations corresponding to the machine readable instructions. Additionally or alternatively, the knowledge manager circuitry 308 may be instantiated by any other combination of hardware, software, and/or firmware. For example, the knowledge manager circuitry 308 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for regulating telemetry data. For example, the means for regulating telemetry data may be implemented by the telemetry regulator circuitry 310. In some examples, the telemetry regulator circuitry 310 may be instantiated by programmable circuitry such as the example programmable circuitry 912 of FIG. 9. For instance, the telemetry regulator circuitry 310 may be instantiated by the example microprocessor 1000 of FIG. 10 executing machine executable instructions such as those implemented by at least blocks 450 of FIG. 4. In some examples, the telemetry regulator circuitry 310 may be instantiated by hardware logic circuitry, which may be implemented by an ASIC, XPU, or the FPGA circuitry 1100 of FIG. 11 structured to perform operations corresponding to the machine readable instructions. Additionally or alternatively, the telemetry regulator circuitry 310 may be instantiated by any other combination of hardware, software, and/or firmware. For example, the telemetry regulator circuitry 310 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for identifying a data recipient. For example, the means for identifying a data recipient may be implemented by the data recipient identifier circuitry 312. In some examples, the data recipient identifier circuitry 312 may be instantiated by programmable circuitry such as the example programmable circuitry 912 of FIG. 9. For instance, the data recipient identifier circuitry 312 may be instantiated by the example microprocessor 1000 of FIG. 10 executing machine executable instructions such as those implemented by at least block 440 of FIG. 4. In some examples, the data recipient identifier circuitry 312 may be instantiated by hardware logic circuitry, which may be implemented by an ASIC, XPU, or the FPGA circuitry 1100 of FIG. 11 structured to perform operations corresponding to the machine readable instructions. Additionally or alternatively, the data recipient identifier circuitry 312 may be instantiated by any other combination of hardware, software, and/or firmware. For example, the data recipient identifier circuitry 312 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the telemetry manager circuitry 207 is illustrated in FIG. 3, one or more of the elements, processes and/or devices illustrated in FIG. 3 may be combined, divided, re-arranged, omitted, eliminated and/or implemented in any other way. Further, the example data receiver circuitry 302, the example data analyzer circuitry 304, the example optimizer circuitry 306, the example knowledge manager circuitry 308, the example telemetry regulator circuitry 310, the example data recipient identifier circuitry 312, and/or, more generally, the example telemetry manager circuitry 207 of FIG. 3 may be implemented by hardware, software, firmware and/or any combination of hardware, software and/or firmware. Thus, for example, any of the example data receiver circuitry 302, the example data analyzer circuitry 304, the example optimizer circuitry 306, the example knowledge manager circuitry 308, the example telemetry regulator circuitry 310, the example data recipient identifier circuitry 312, and/or, more generally, the example telemetry manager circuitry 207 of FIG. 3 could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s), ASIC(s)), programmable logic device(s) (PLD(s)), and/or field programmable logic device(s) (FPLD(s)) such as FPGAs. Further still, the telemetry manager circuitry 207 of FIG. 3 may include one or more elements, processes, and/or devices in addition to, or instead of, those illustrated in FIG. 3, and/or may include more than one of any or all of the illustrated elements, processes and devices.

Flowcharts representative of example machine readable instructions, which may be executed by programmable circuitry to implement and/or instantiate the telemetry manager circuitry 207 of FIG. 3 and/or representative of example operations which may be performed by programmable circuitry to implement and/or instantiate the telemetry manager circuitry 207 of FIG. 3, are shown in FIGS. 4-5. The machine readable instructions may be one or more executable programs or portion(s) of one or more executable programs for execution by programmable circuitry, such as the programmable circuitry 912 shown in the example processor platform 900 discussed below in connection with FIG. 9 and/or may be one or more function(s) or portion(s) of functions to be performed by the example programmable circuitry (e.g., an FPGA) discussed below in connection with FIGS. 10 and/or 11. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowcharts illustrated in FIGS. 4-5, many other methods of implementing the example telemetry manager circuitry 207 of FIG. 3 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 4-5 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, and/or activities, the phrase “at least one of A and B” is intended to refer to implementations including any of (1) at least one A, (2) at least one B, or (3) at least one A and at least one B. Similarly, as used herein in the context of describing the performance or execution of processes, instructions, actions, and/or activities, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

FIG. 4 is a flowchart representative of example machine readable instructions and/or example operations 400 that may be executed, instantiated, and/or performed by programmable circuitry to implement the example telemetry manager circuitry 207 of FIG. 3. The machine readable instructions and/or the operations 300 of FIG. 3 begin at block 405, at which the data receiver circuitry 302 generates telemetry data. For example, the data receiver circuitry 302 receives initial data from the edge device (e.g., temperature, pressure, video recording, etc.) that can be used for adjustment, assessment and/or analysis prior to being transmitted to the one or more decision maker(s) 208, 210, 215. For example, prior to receiving feedback from the decision maker(s) regarding the utility of the telemetry data that is being provided to the decision maker(s) associated with a particular edge device, the data receiver circuitry 302 generates telemetry data based on particular metrics that are being monitored by the edge device (e.g., temperature, etc.). The data analyzer circuitry 304 performs data analysis on the telemetry data generated by the data receiver circuitry 302, at block 410. For example, the data analyzer circuitry 304 performs specific combinations and/or syntheses of the telemetry data obtained using the data receiver circuitry 302. In some examples, the data analyzer circuitry 304 performs low-level analyses on the raw telemetry data, including unidimensional analysis and/or longitudinal analysis for a given time window and set of events (e.g., energy consumption peak, processor frequency peaks, etc.). This allows the data analyzer circuitry 304 to generate a pattern corresponding to the identified data features (e.g., granularity, variability, etc.), at block 415. The telemetry regulator circuitry 310 transmits the telemetry-based data to the decision maker(s), at block 420. For example, the decision maker can be a meteorology station receiving telemetry data from an edge device collecting information identifying various markers of interest for weather forecasting (e.g., temperature, pressure, humidity, etc.).

The data receiver circuitry 302 identifies whether feedback from the decision maker(s) has been received, at block 425. For example, the decision maker(s) receiving the telemetry data can report the utility of the received data. In some examples, the decision maker(s) identify whether the generated telemetry was useful to the decision-making process. For example, the generated telemetry data is associated with a particular telemetry pattern, which can then be identified as a pattern that was useful or was not useful to a particular decision maker. If the telemetry pattern was not useful, the edge device can implement other pattern(s) to determine which pattern(s) bring greater utility to the decision maker(s) receiving the telemetry data from a particular edge device. As such, the optimizer circuitry 306 updates the telemetry pattern(s) based on feedback received from the decision maker, at block 430, as described in more detail in connection with FIG. 5. For example, the optimizer circuitry 306 reaches an optimal combination of content, granularity, and/or variability to produce added value for the global measurement objective of the decision maker.

Once the telemetry pattern(s) are generated, the knowledge manager circuitry 308 stores the generated patterns in a pattern database. Over time, the pattern(s) are updated based on data received from neighboring edge device(s). For example, the data recipient identifier circuitry 312 identifies neighboring edge device(s) to facilitate swarm intelligence, such that pattern data is shared and updated to allow the edge device(s) to implement the type of pattern that is shown to be most useful to a particular decision maker In the example of FIG. 4, the data recipient identifier circuitry 312 identifies the presence of additional edge device(s), at block 435. In some examples, the data recipient identifier circuitry 312 identifies edge device(s) that are in proximity based on latency or physical distance. However, edge device(s) can be considered neighboring edge device(s) based on any other type of criteria (e.g., type of data collection, frequency of data collection, physical location, etc.). Upon identifying additional edge device(s), the data recipient identifier circuitry 312 receives and/or transmits pattern(s) to and/or from the edge device(s), at block 440. The telemetry regulator circuitry 310 identifies the received pattern(s) and/or chooses pattern(s) to implement for a particular decision maker, at block 445. The knowledge manager circuitry 308 stores the received pattern(s) in a pattern database, allowing the edge device to access pattern(s) received from neighboring edge devices. As such, the telemetry regulator circuitry 310 updates the telemetry data based on the selected pattern(s), at block 450.

FIG. 5 is a flowchart representative of example machine readable instructions and/or example operations 4300 that may be executed, instantiated, and/or performed by programmable circuitry to implement the example telemetry manager circuitry 207 of FIG. 3 to update pattern(s) based on feedback. The machine readable instructions and/or the operations 430 of FIG. 5 begin at block 505, at which the optimizer circuitry 306 creates a search space (e.g., of telemetry characteristics) based on existing telemetry pattern(s). For example, the optimizer circuitry 306 creates a search space based on the telemetry pattern database to determine how to satisfy a given decision maker. As described in connection with FIG. 4, the edge device can create its own knowledge database (e.g., of telemetry pattern data) in a decentralized manner. The optimizer circuitry 306 uses the telemetry pattern database to further identify optimal combinations of content, granularity, and/or variability, at block 510. For example, the optimizer circuitry 306 can determine which type(s) of pattern(s) are relevant for a particular decision maker that receives telemetry data from the edge device. In some examples, the optimizer circuitry 306 identifies a level of utility associated with a previous pattern, at block 515. For example, the optimizer circuitry 306 determines a utility score associated with a particular pattern, based on feedback received from the decision maker (e.g., a score between 0% and 100% to describe the level of utility, a binary identifier of utility such as 0 for unhelpful data and 1 for helpful data, etc.). In the example of FIG. 5, the knowledge manager circuitry 308 autonomously and/or dynamically updates and/or debugs the local patterns generated by the edge device based on the contribution of the telemetry data to the decision maker's measurement objective, at block 520. For example, the pattern(s) can be changed to allow for the edge device to provide telemetry data that is useful to the decision maker In some examples, patterns can be updated based on data received from neighboring edge devices. Subsequently, the telemetry regulator circuitry 310 updates local data collection, processing, data buffering, and/or data transmission, at block 525. As such, the edge device can provide updated telemetry data to a given decision maker once the pattern(s) have been optimized to meet the decision maker's global objectives.

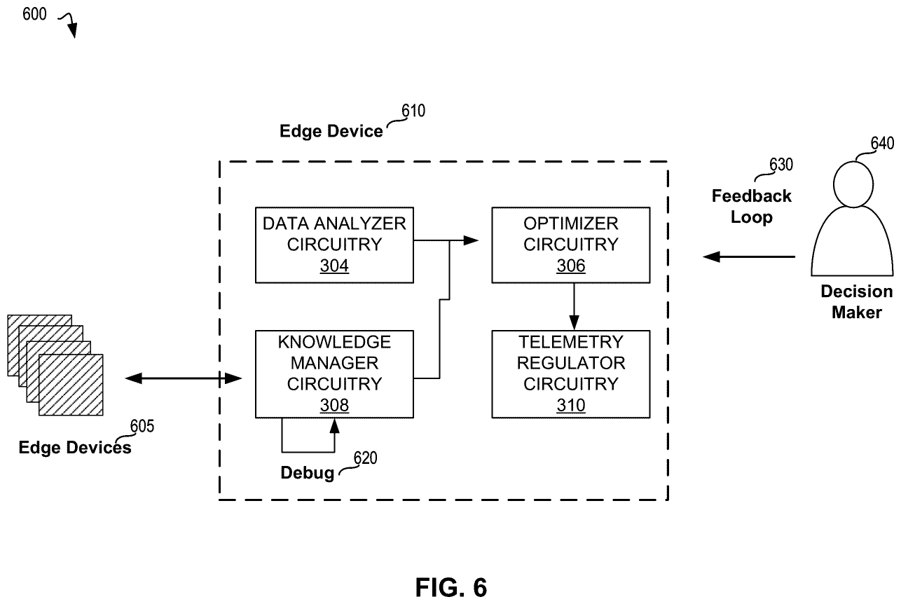

FIG. 6 is an example of architecture 600 used for performing telemetry resource management associated with multiple edge devices. In the example of FIG. 6, edge device(s) 605 are in communication with edge device 610, providing telemetry pattern data to the knowledge manager circuitry 308. As described in connection with FIG. 5, the knowledge manager circuitry 308 can perform debugging 620 of patterns based on contributions to the decision maker's measurement objective. Separately, the data analyzer circuitry 304 performs different levels of data analysis on the telemetry data (e.g., combinations, synthesis, etc.). The optimizer circuitry 306 uses the knowledge database (e.g., proper and third-past experiences with feedback modeled as patterns) to create a search space and reach the best combination of content, granularity, and/or variability, producing added value for the global measurement objective. Furthermore, the optimizer circuitry 306 receives, processes, and/or updates the local knowledge database asynchronously with an example feedback loop 630 from the global decision-maker process running a global optimization workload. For example, the decision maker 640 identifies whether the last informed telemetry was helpful enough or not (e.g., a score between 0% and 100% describing the level of utility). The knowledge manager circuitry 308 then updates and debugs autonomously and dynamically the telemetry patterns based on the contribution to the measurement objective over time, sharing information with the neighbor edge devices 605.

The telemetry regulator circuitry 310 further implements the directives (e.g., patterns) that the optimizer circuitry 306 provides to update and/or change the local data collection, processing, data buffering, and/or data transmission strategy over time. As such, an autonomous and dynamic mechanism is introduced for regulating over time the kind of telemetry content to collect, the associated granularity level, and/or the events under consideration, fostering a continuous alignment with the global decision-making objective based on feedback loops. Therefore, edge devices can regulate and inform meaningful and added-value telemetry according to the measurement objective, regulating data transmissions, optimizing local retention policies, and/or fostering swarm intelligence for sharing learned contribution patterns with other edge devices. Locally at a given edge device, metric-based names can represent identifiers associating a particular string (e.g., metric 1) with a specific set of values over time without representing meaning modeling (e.g., an ontology-based approach). In examples disclosed herein, how metric-based values behave over time and how those values contribute to system variability can be assessed based on a data-driven decision-making approach. For example, an edge device provides telemetry data to a decision-maker (e.g., data consumer) for supporting a decision-making process, identifying the combinations between metrics and granularity that provide the best contribution with the lowest cost for the decision-maker perspective (e.g., based on a number of transmissions and associated data volume), adjusting the data collection process dynamically as needed to satisfy the needs of the decision maker(s) receiving the telemetry data. Furthermore, a key-value approach allows the edge device to keep track of different metrics and a set of different unidimensional perspectives, which can be detailed (e.g., last five minutes of raw data) or synthesized following a given logic (e.g., descriptive analysis). For example, considering the utility of a particular granularity level for the decision-maker (e.g., the component consuming the telemetry to support a particular decision) or how a particular metric contributes to a decision, allows for optimization of the data collection process, since higher data volumes result in a higher cost of telemetry processing and the associated transmission time required to inform the decision maker using larger datasets.

FIG. 7 in an example stage-based process 700 for performing telemetry data collection, variability analysis, iterative granularity assessment, and optimization and tracking based on a feedback loop associated with a decision maker In the example of FIG. 7, the data analyzer circuitry 304 collects telemetry data based on metric identifiers (e.g., at a first stage 705), producing different types of low-level analyses on the raw data, such as unidimensional analysis (e.g., descriptive analysis, outlier analysis, missing value analysis, etc.) and/or longitudinal analysis (e.g., multivariate outlier analysis) for a given time window and/or set of events (e.g., energy consumption peak, processor frequency peaks, etc.). At example second stage 710, the data analyzer circuitry 304 analyzes how the combination of variables could affect the system variability and assesses the combination of variables over time under a current granularity level and/or set of events. At an example third stage 715, the data analyzer circuitry 304 varies the granularity levels and/or potential events on analysis pipelines related to the first and second stages iteratively, replacing or altering metrics or events by others with equal or different levels of granularity. An example fourth stage 720, the optimizer circuitry 306 performs optimization that contrasts feedback loop information 745 received historically from the decision-making process (e.g., from decision maker 740) about past contributions with the current contribution, creating a search space using this information, and/or running an AI-based optimization algorithm to reach the maximum contribution. For example, output 725 of the fourth stage 720 includes data content, granularity level combinations, and transmission frequencies, which can be added to a patterns database 730. The output 725 determines the current combination pattern of granularity levels per metric (or a combination of patterns and how to combine those patterns) and the event combinations to monitor jointly with the transmission frequency to adjust the local telemetry system. The granularity and event-based telemetry output 735 (e.g., based on patterns database 730) is provided to the decision maker 740, resulting in the feedback loop 745 that allows for further optimization to take place as part of the fourth stage 720.

FIG. 8 is an example of pattern sharing 800, including data content for telemetry, granularity level, events, and magnitudes of contribution to objective-oriented decision-making processes. For example, learned patterns locally represent knowledge based on previous experiences and are supported by the feedback loop, as shown in connection with FIG. 7. As such, the data content for telemetry, granularity level, events, and/or the magnitude of contribution to the objective-oriented decision-making process can be identified (e.g., for global power consumption optimization, etc.). The data recipient identifier circuitry 312 shares these patterns collaboratively among the neighbor nodes to increase the pattern-based knowledge database and transitively enrich the search space for the optimizer circuitry 306. For example, different edge devices can have different perspectives of the knowledge database depending on their respective nodes, allowing for the mitigation of local optimization concerns through a swarm intelligence approach. In some examples, a given edge device shares its patterns and decides autonomously on those patterns that could be incorporated or retained over time from other neighbor edge devices based on the potential contribution to the edge devices' database(s). If a given pattern from another edge device does not increase the benefit of global variability explanation in a particular instant, such patterns can be omitted or removed while keeping a record of these pattern removal decisions. This mechanism pursues an autonomous and continuous alignment with the global decision-making objective and dynamically fosters the local database's debugging.

In the example of FIG. 8, an edge device 805 can use select identifiers 810 (e.g., events, time window in which to collect information, telemetry pipelines to process, etc.) to generate a telemetry pattern database 815 using the knowledge manager circuitry 308 (e.g., balancing a set of data relevant to particular decision makers), where the database 815 includes local pattern(s) generated by the edge device 805 as well as patterns 820 provided by neighboring edge device(s) 825, 850, 870. In some examples, the patterns can be used to define the telemetry to send to the decision maker(s) and/or which metrics to collect. Likewise, the neighboring edge device(s) 825, 850, 870 can share their pattern(s) with newly added neighboring edge device(s). For example, edge device 825 uses the data recipient identifier circuitry 312 to share pattern data with newly added edge device(s) 830, 835, 840, creating a database of patterns 845, edge device 850 can share pattern data with newly added edge device(s) 855, 860, creating a database of patterns 865, and edge device 870 can share pattern data with newly added edge device(s) 875, 880, 885, creating a database of patterns 890. As such, the newly added edge device(s) can have access to the pattern databases 845, 865, and/or 890 to identify which telemetry data can be sent to their particular decision maker(s), without needing to start their individual pattern collection databases from the beginning.

FIG. 9 is a block diagram of an example programmable circuitry platform 900 structured to execute and/or instantiate the example machine-readable instructions and/or the example operations of FIGS. 4-5 to implement the example telemetry manager circuitry 207 of FIG. 3. The programmable circuitry platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAs microprocessors, CPUs, GPUs, DSPs, and/or microcontrollers from any desired family or manufacturer. The programmable circuitry 912 may be implemented by one or more semiconductor based (e.g., silicon based) devices. In this example, the processor circuitry 912 implements the data receiver circuitry 302, the data analyzer circuitry 304, the optimizer circuitry 306, the knowledge manager circuitry 308, the telemetry regulator circuitry 310, and the data recipient identifier circuitry 312.

The programmable circuitry 912 of the illustrated example includes a local memory 913 (e.g., a cache, registers, etc.). The programmable circuitry 912 of the illustrated example is in communication with a main memory including a volatile memory 914 and a non-volatile memory 916 by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916.

The programmable circuitry platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, an audio sensor, a microphone, a camera (still or video), a keyboard, a button, a mouse, a touchscreen, a track-pad, a trackball, an isopoint device, and/or a voice recognition system.

One or more output devices 924 are also connected to the interface circuitry 920 of the illustrated example. The output devices 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The programmable circuitry platform 900 of the illustrated example also includes one or more mass storage devices 928 to store software and/or data. Examples of such mass storage devices 928 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine executable instructions 932, which may be implemented by the machine readable instructions of FIGS. 4-5, may be stored in the mass storage device 928, in the volatile memory 914, in the non-volatile memory 916, and/or on at least one non-transitory computer readable storage medium such as a CD or DVD which may be removable.

FIG. 10 is a block diagram of an example implementation of the programmable circuitry 912 of FIG. 9. In this example, the programmable circuitry 912 of FIG. 9 is implemented by a microprocessor 1000. For example, the microprocessor 1000 may be a general purpose microprocessor (e.g., general purpose microprocessor circuitry). The microprocessor 1000 executes some or all of the machine readable instructions of the flowcharts of FIGS. 4-5 to effectively instantiate the circuitry of FIG. 3 logic circuits to perform the operations corresponding to those machine readable instructions. In some such examples, the circuitry of FIG. 3 is instantiated by the hardware circuits of the microprocessor 1000 in combination with the instructions. For example, the microprocessor 1000 may implement multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine readable instructions and/or operations represented by the flowcharts of FIGS. 4-5.

The cores 1002 may communicate by a first example bus 1004. In some examples, the first bus 1004 may implement a communication bus to effectuate communication associated with one(s) of the cores 1002. For example, the first bus 1004 may implement at least one of an Inter-Integrated Circuit (I2C) bus, a Serial Peripheral Interface (SPI) bus, a PCI bus, or a PCIe bus. Additionally or alternatively, the first bus 1004 may implement any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2_cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry (sometimes referred to as an ALU) 1016, a plurality of registers 1018, the L1 cache 1020, and a second example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control (e.g., coordinate) data movement within the corresponding core 1002. The AL circuitry 1016 includes semiconductor-based circuits structured to perform one or more mathematic and/or logic operations on the data within the corresponding core 1002. The AL circuitry 1016 of some examples performs integer-based operations. In other examples, the AL circuitry 1016 also performs floating-point operations. In yet other examples, the AL circuitry 1016 may include first AL circuitry that performs integer-based operations and second AL circuitry that performs floating point operations. In some examples, the AL circuitry 1016 may be referred to as an Arithmetic Logic Unit (ALU).

The registers 1018 are semiconductor-based structures to store data and/or instructions such as results of one or more of the operations performed by the AL circuitry 1016 of the corresponding core 1002. For example, the registers 1018 may include vector register(s), SIMD register(s), general purpose register(s), flag register(s), segment register(s), machine specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure including distributed throughout the core 1002 to shorten access time. The second bus 1022 may be implemented by at least one of an I2C bus, a SPI bus, a PCI bus, or a PCIe bus.

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages.

The microprocessor 1000 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1000, in the same chip package as the microprocessor 1000 and/or in one or more separate packages from the microprocessor 1000.

FIG. 11 is a block diagram of another example implementation of the programmable circuitry of FIG. 9. In this example, the programmable circuitry 912 is implemented by FPGA circuitry 1100. For example, the FPGA circuitry 1100 may be implemented by an FPGA. The FPGA circuitry 1100 can be used, for example, to perform operations that could otherwise be performed by the example microprocessor 1000 of FIG. 10 executing corresponding machine readable instructions. However, once configured, the FPGA circuitry 1100 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1000 of FIG. 10 described above (which is a general purpose device that may be programmed to execute some or all of the machine readable instructions represented by the flowcharts of FIGS. 4-5 but whose interconnections and logic circuitry are fixed once fabricated), the FPGA circuitry 1100 of the example of FIG. 11 includes interconnections and logic circuitry that may be configured, structured, programmed, and/or interconnected in different ways after fabrication to instantiate, for example, some or all of the operations/functions corresponding to the machine readable instructions represented by the flowcharts of FIGS. 4-5. In particular, the FPGA 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 4-5. As such, the FPGA circuitry 1100 may be configured and/or structured to effectively instantiate some or all of the operations/functions corresponding to the machine readable instructions of the flowcharts of FIGS. 4-5 as dedicated logic circuits to perform the operations/functions corresponding to those software instructions in a dedicated manner analogous to an ASIC. Therefore, the FPGA circuitry 1100 may perform the operations/functions corresponding to the some or all of the machine readable instructions of FIGS. 4-5 faster than the general-purpose microprocessor can execute the same.

In the example of FIG. 11, the FPGA circuitry 1100 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

The FPGA circuitry 1100 of FIG. 11, includes example input/output (I/O) circuitry 1102 to obtain and/or output data to/from example configuration circuitry 1104 and/or external hardware 1106. For example, the configuration circuitry 1104 may be implemented by interface circuitry that may obtain a binary file, which may be implemented by a bit stream, data, and/or machine-readable instructions, to configure the FPGA circuitry 1100, or portion(s) thereof. In some such examples, the configuration circuitry 1104 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1106 may be implemented by external hardware circuitry. For example, the external hardware 1106 may be implemented by the microprocessor 1000 of FIG. 10.

The FPGA circuitry 1100 also includes an array of example logic gate circuitry 1108, a plurality of example configurable interconnections 1110, and example storage circuitry 1112. The logic gate circuitry 1108 and the configurable interconnections 1110 are configurable to instantiate one or more operations/functions that may correspond to at least some of the machine readable instructions of FIGS. 4-5 and/or other desired operations. The logic gate circuitry 1108 shown in FIG. 11 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations/functions. The logic gate circuitry 1108 may include other electrical structures such as look-up tables (LUTs), registers (e.g., flip-flops or latches), multiplexers, etc.

The configurable interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example dedicated operations circuitry 1114. In this example, the dedicated operations circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the programmable circuitry 912 of FIG. 9, many other approaches are contemplated. For example, FPGA circuitry may include an on-board CPU, such as one or more of the example CPU 1120 of FIG. 11. Therefore, the programmable circuitry 912 of FIG. 9 may additionally be implemented by combining at least the example microprocessor 1000 of FIG. 10 and the example FPGA circuitry 1100 of FIG. 11. In some such hybrid examples, one or more cores 1102 of FIG. 11 may execute a first portion of the machine readable instructions represented by the flowchart(s) of FIGS. 4-5 to perform first operation(s)/function(s), the FPGA circuitry 1100 of FIG. 11 may be configured and/or structured to perform second operation(s)/function(s) corresponding to a second portion of the machine readable instructions represented by the flowcharts of FIGS. 4-5, and/or an ASIC may be configured and/or structured to perform third operation(s)/function(s) corresponding to a third portion of the machine readable instructions represented by the flowcharts of FIGS. 4-5.

It should be understood that some or all of the circuitry of FIG. 3 may, thus, be instantiated at the same or different times. For example, same and/or different portion(s) of the microprocessor 1000 of FIG. 10 may be programmed to execute portion(s) of machine-readable instructions at the same and/or different times. In some examples, same and/or different portion(s) of the FPGA circuitry 1100 of FIG. 11 may be configured and/or structured to perform operations/functions corresponding to portion(s) of machine-readable instructions at the same and/or different times.

In some examples, some or all of the circuitry of FIG. 3 may be instantiated, for example, in one or more threads executing concurrently and/or in series. For example, the microprocessor 1000 of FIG. 10 may execute machine readable instructions in one or more threads executing concurrently and/or in series. In some examples, the FPGA circuitry 1100 of FIG. 11 may be configured and/or structured to carry out operations/functions concurrently and/or in series. Moreover, in some examples, some or all of the circuitry of FIG. 3 may be implemented within one or more virtual machines and/or containers executing on the microprocessor 1000 of FIG. 10.

In some examples, the programmable circuitry 912 of FIG. 9 may be in one or more packages. For example, the microprocessor 1000 of FIG. 10 and/or the FPGA circuitry 1100 of FIG. 11 may be in one or more packages. In some examples, an XPU may be implemented by the programmable circuitry 912 of FIG. 4 which may be in one or more packages. For example, the XPU may include a CPU (e.g., the microprocessor 1000 of FIG. 10, the CPU 1120 of FIG. 11, etc.) in one package, a DSP (e.g., the DSP 1122 of FIG. 11) in another package, a GPU in yet another package, and an FPGA (e.g., the FPGA circuitry 1100 of FIG. 11) in still yet another package.

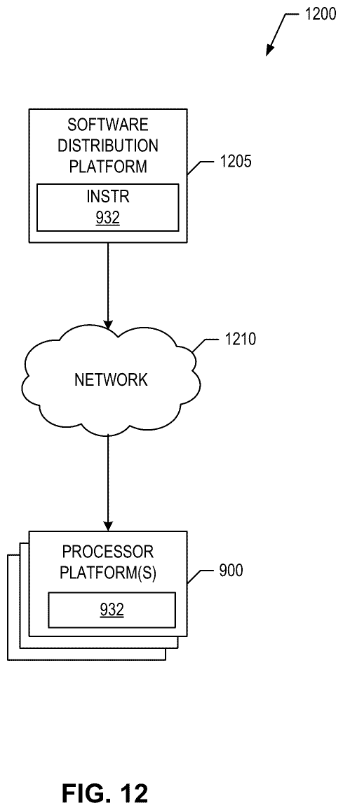

A block diagram illustrating an example software distribution platform 1205 to distribute software such as the example machine readable instructions 932 of FIG. 9 to other hardware devices (e.g., hardware devices owned and/or operated by third parties from the owner and/or operator of the software distribution platform) is illustrated in FIG. 12. The example software distribution platform 1205 may be implemented by any computer server, data facility, cloud service, etc., capable of storing and transmitting software to other computing devices. The third parties may be customers of the entity owning and/or operating the software distribution platform 1205. For example, the entity that owns and/or operates the software distribution platform 1205 may be a developer, a seller, and/or a licensor of software such as the example machine readable instructions 932 of FIG. 9. The third parties may be consumers, users, retailers, OEMs, etc., who purchase and/or license the software for use and/or re-sale and/or sub-licensing. In the illustrated example, the software distribution platform 1205 includes one or more servers and one or more storage devices. The storage devices store the machine readable instructions 932, which may correspond to the example machine readable instructions of FIGS. 4-5, as described above. The one or more servers of the example software distribution platform 905 are in communication with an example network 910, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 932 from the software distribution platform 1205. For example, the software, which may correspond to the example machine readable instructions of FIGS. 4-5, may be downloaded to the example programmable circuitry platform 900, which is to execute the machine readable instructions 932 to implement the telemetry manager circuitry 207. In some examples, one or more servers of the software distribution platform 1205 periodically offer, transmit, and/or force updates to the software (e.g., the example machine readable instructions 932 of FIG. 9) to ensure improvements, patches, updates, etc., are distributed and applied to the software at the end user devices. Although referred to as software above, the distributed “software” could alternatively be firmware.

From the foregoing, it will be appreciated that example systems, methods, apparatus, and articles of manufacture for telemetry granularity management has been disclosed. In examples disclosed herein, telemetry-based data collection associated with edge device(s) can be adjusted based on a feedback loop. For example, local decisions (e.g., adjustment of telemetry data granularity levels, metric combinations, events, etc.) and determined impacts on the global measurement objective permit identification of local patterns. In examples disclosed herein, a knowledge database of pattern data is created to track patterns from various edge device(s) as part of swarm intelligence. The patterns can be debugged over time to keep pertinency of the patterns aligned with the global measurement aim. As such, methods and apparatus disclosed herein foster pattern sharing among edge devices and swarm intelligence, allowing a given node to decide autonomously (e.g., using artificial intelligence) whether to incorporate select patterns as determined based on local utility feedback from the decision maker(s). In examples disclosed herein, telemetry pattern data is used to update and change edge device-based local data collection, processing, data buffering, and/or data transmission strategies. Likewise, newly added edge device(s) can receive existing telemetry pattern data to determine which pattern(s) can be applicable to their particular telemetry data-receiving decision maker(s).

Example methods, apparatus, systems, and articles of manufacture for telemetry granularity management are disclosed herein. Further examples and combinations thereof include the following:
Example 1 includes a first device comprising interface circuitry, machine readable instructions, and programmable circuitry to operate based on the machine readable instructions to update configuration data based on a telemetry pattern from a second device, the second device to satisfy a neighbor condition, generate telemetry data based on the configuration data, and update the first set of data based on feedback from a recipient of the telemetry data.
Example 2 includes the first device of example 1, wherein the neighbor condition identifies at least one of a proximity between the first device and the second device or a latency between the first device and the second device.
Example 3 includes the first device of example 2, wherein the telemetry pattern is to specify a characteristic of the telemetry data to be generated by the first device, the characteristic at least one of a granularity of the telemetry data or a variability of the telemetry data.
Example 4 includes the first device of example 1, wherein the programmable circuitry is to obtain a second telemetry pattern from a third device, the third device to satisfy the neighbor condition, and update the configuration data based on the second telemetry pattern.
Example 5 includes the first device of example 1, wherein the programmable circuitry is to generate a search space of telemetry characteristics based on the configuration data.
Example 6 includes the first device of example 1, wherein the programmable circuitry is to identify a level of utility associated with the telemetry data, the level of utility based on the feedback from the recipient.
Example 7 includes the first device of example 6, wherein the programmable circuitry is to update at least one of local data collection, data processing, data buffering, or data transmission based on the level of utility.
Example 8 includes a method comprising updating, at a first device, configuration data based on a telemetry pattern from a second device, the second device to satisfy a neighbor condition, generating telemetry data based on the configuration data, and updating the first set of data based on feedback from a recipient of the telemetry data.
Example 9 includes the method of example 8, wherein the neighbor condition identifies at least one of a proximity between the first device and the second device or a latency between the first device and the second device.
Example 10 includes the method of example 9, wherein the telemetry pattern is to specify a characteristic of the telemetry data to be generated by the first device, the characteristic at least one of a granularity of the telemetry data or a variability of the telemetry data.
Example 11 includes the method of example 8, further including obtaining a second telemetry pattern from a third device, the third device to satisfy the neighbor condition, and updating the configuration data based on the second telemetry pattern.
Example 12 includes the method of example 11, further including generating a search space of telemetry characteristics based on the configuration data.
Example 13 includes the method of example 8, further including identifying a level of utility associated with the telemetry data, the level of utility based on the feedback from the recipient.
Example 14 includes the method of example 13, further including updating at least one of local data collection, data processing, data buffering, or data transmission based on the level of utility.
Example 15 includes a non-transitory machine readable storage medium comprising instructions to cause programmable circuitry to at least updating, at a first device, configuration data based on a telemetry pattern from a second device, the second device to satisfy a neighbor condition, generating telemetry data based on the configuration data, and updating the first set of data based on feedback from a recipient of the telemetry data.
Example 16 includes the non-transitory machine readable storage medium of example 15, wherein the neighbor condition identifies at least one of a proximity between the first device and the second device or a latency between the first device and the second device.
Example 17 includes the non-transitory machine readable storage medium as defined in example 16, wherein the telemetry pattern is to specify a characteristic of the telemetry data to be generated by the first device, the characteristic at least one of a granularity of the telemetry data or a variability of the telemetry data.
Example 18 includes the non-transitory machine readable storage medium as defined in example 15, wherein the instructions are to cause the programmable circuitry to obtain a second telemetry pattern from a third device, the third device to satisfy the neighbor condition, and update the configuration data based on the second telemetry pattern.
Example 19 includes the non-transitory machine readable storage medium as defined in example 18, wherein the instructions are to cause the programmable circuitry to generate a search space of telemetry characteristics based on the configuration data.
Example 20 includes the non-transitory machine readable storage medium as defined in example 15, wherein the instructions are to cause the programmable circuitry to identify a level of utility associated with the telemetry data, the level of utility based on the feedback from the recipient.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. A first device comprising:
interface circuitry;
machine readable instructions; and
programmable circuitry to operate based on the machine readable instructions to:
update configuration data based on a telemetry pattern from a second device, the second device to satisfy a neighbor condition;
generate telemetry data based on the configuration data; and
update the first set of data based on feedback from a recipient of the telemetry data.

2. The first device of claim 1, wherein the neighbor condition identifies at least one of a proximity between the first device and the second device or a latency between the first device and the second device.

3. The first device of claim 2, wherein the telemetry pattern is to specify a characteristic of the telemetry data to be generated by the first device, the characteristic at least one of a granularity of the telemetry data or a variability of the telemetry data.

4. The first device of claim 1, wherein the programmable circuitry is to:
obtain a second telemetry pattern from a third device, the third device to satisfy the neighbor condition; and
update the configuration data based on the second telemetry pattern.

5. The first device of claim 1, wherein the programmable circuitry is to generate a search space of telemetry characteristics based on the configuration data.

6. The first device of claim 1, wherein the programmable circuitry is to identify a level of utility associated with the telemetry data, the level of utility based on the feedback from the recipient.

7. The first device of claim 6, wherein the programmable circuitry is to update at least one of local data collection, data processing, data buffering, or data transmission based on the level of utility.

8. A method comprising:
updating, at a first device, configuration data based on a telemetry pattern from a second device, the second device to satisfy a neighbor condition;
generating telemetry data based on the configuration data; and
updating the first set of data based on feedback from a recipient of the telemetry data.

9. The method of claim 8, wherein the neighbor condition identifies at least one of a proximity between the first device and the second device or a latency between the first device and the second device.

10. The method of claim 9, wherein the telemetry pattern is to specify a characteristic of the telemetry data to be generated by the first device, the characteristic at least one of a granularity of the telemetry data or a variability of the telemetry data.

11. The method of claim 8, further including:
obtaining a second telemetry pattern from a third device, the third device to satisfy the neighbor condition; and
updating the configuration data based on the second telemetry pattern.

12. The method of claim 11, further including generating a search space of telemetry characteristics based on the configuration data.

13. The method of claim 8, further including identifying a level of utility associated with the telemetry data, the level of utility based on the feedback from the recipient.

14. The method of claim 13, further including updating at least one of local data collection, data processing, data buffering, or data transmission based on the level of utility.

15. A non-transitory machine readable storage medium comprising instructions to cause programmable circuitry to at least:
updating, at a first device, configuration data based on a telemetry pattern from a second device, the second device to satisfy a neighbor condition;
generating telemetry data based on the configuration data; and
updating the first set of data based on feedback from a recipient of the telemetry data.

16. The non-transitory machine readable storage medium of claim 15, wherein the neighbor condition identifies at least one of a proximity between the first device and the second device or a latency between the first device and the second device.

17. The non-transitory machine readable storage medium as defined in claim 16, wherein the telemetry pattern is to specify a characteristic of the telemetry data to be generated by the first device, the characteristic at least one of a granularity of the telemetry data or a variability of the telemetry data.

18. The non-transitory machine readable storage medium as defined in claim 15, wherein the instructions are to cause the programmable circuitry to:
obtain a second telemetry pattern from a third device, the third device to satisfy the neighbor condition; and
update the configuration data based on the second telemetry pattern.

19. The non-transitory machine readable storage medium as defined in claim 18, wherein the instructions are to cause the programmable circuitry to generate a search space of telemetry characteristics based on the configuration data.

20. The non-transitory machine readable storage medium as defined in claim 15, wherein the instructions are to cause the programmable circuitry to identify a level of utility associated with the telemetry data, the level of utility based on the feedback from the recipient.
